(19) United States
(12) Patent Application Publication
(10) Pub. No.: US 2020/0355327 A1
(43) Pub. Date: Nov. 12, 2020

(54) INTERNET ENABLED LED REPLACEMENT KIT FOR HIGH INTENSITY DISCHARGE LIGHT

(71) Applicant: SIMPLY LEDS, LLC, Garden City, ID (US)

(72) Inventors: Robert Deely, Garden City, ID (US); Daniel Donegan, Garden City, ID (US)

(21) Appl. No.: 16/872,356

(22) Filed: May 11, 2020

Related U.S. Application Data
(60) Provisional application No. 62/846,444, filed on May 10, 2019.

(51) Int. Cl. F21K 9/00; F21V 29/76; F21V 23/00; F21V 23/04; H05B 47/115; H05B 47/11; H05B 47/19; H05B 45/12; H05B 47/12

(52) U.S. Cl. CPC F21K 9/00; F21V 29/763; F21V 23/005; F21V 23/045; F21V 23/0464; F21Y 2115/10; H05B 47/115; H05B 47/11; H05B 47/19; H05B 45/12; H05B 47/12; F21V 23/0471

(57) ABSTRACT

A kit for retrofitting an existing high intensity discharge fixture so that it operates with one or more LED bulbs. The LED kit includes a bypass ballast for supplying current to an LED replacement bulb; an LED bulb, preferably set at an angle to aim the distribution of light; a heat sink for controlling the heat from the LED bulb; a dimmer unit, for adjusting the light intensity of the LED bulb; a sensor linked to the dimmer unit or controller, to adjust the intensity of the LED bulb based on a measured input; a controller configured for controlling the dimmer and for communicating to separate devices, such as a computer or other mobile device, via a router and a wireless transceiver Internet via WIFI or a cellular connection. In a preferred embodiment the kit includes one or more lenses for even distribution of light from the LED bulb.

### PRIORITY/CROSS-REFERENCE TO RELATED APPLICATIONS

This application claims the benefit of U.S. Provisional Application No. 62/846,444, filed May 10, 2019, the disclosure of which is incorporated by reference.

### TECHNICAL FIELD

The disclosure generally relates to the field of lighting. Particular embodiments relate to providing a retrofit LED light kit that is configured to connect to the internet to provide for monitoring and/or control of the LED light kit from a remote location.

### BACKGROUND

The installed bases of high intensity discharge light fixtures are used in many situations where a large area must be lighted. This includes in parking lots, in street lights, inside warehouses, and other large buildings. The installed base of high intensity discharge fixtures may include mercury vapor, metal halide, fluorescent or other types of bulbs. What is needed is a kit for retrofitting an existing high intensity discharge fixture so that it operates with one or more LED bulbs.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a kit for retrofitting an existing high intensity discharge fixture so that it operates with one or more LED bulbs. The LED kit can include a bypass ballast, by which line current is transformed and conditioned to supply power to the LED bulbs. The kit also includes one or more LED bulbs, with a preferred configuration being eight LEDs each providing 375 lumens of light. Such a configuration uses 20 watts of electricity compared to the 100 watts which the light it replaces typically utilizes. The kit can be set at an angle so that they may be aimed at a selected position below the light fixture.

The kit for retrofitting an existing high intensity discharge lamp preferably includes an LED replacement bulb, set at an angle to project light at a desired area. The LED kit also preferably includes one or more lenses for even distribution of light from the LED bulb. The lens(es) may be placed over the LEDs so that the light from the LEDs is evenly dispersed over an area. These lenses can be customized to suit the dispersion or concentration preferences of a particular location.

In a preferred embodiment, the retrofit kit includes a dimmer which may be computer or sensor controlled. The computer controlled dimmer may be controllable from a console at a security station or remotely from an Internet connection, from which the light may be briefly intensified beyond the thermal limits in order to view an area for security purposes. The dimmer may also be attached to sensors, the signal from which can be used to reduce the output of the LED dependent on the condition sensed by the sensor(s).

In a preferred embodiment a sensor is linked to the dimmer unit, to adjust the intensity of the LED bulb based on a measured input. In one embodiment, sensor may detect motion, and would turn the light on whenever motion is detected or initiate a camera taking pictures or video. In another embodiment, a different sensor might be utilized to detect whether it is daylight or nighttime outside, with the LED dimmed during the daytime. In another embodiment, the sensor may detect sound, with the LED lights turned to a higher output when a sound is detected. Other sensors may be utilized for detecting chemicals in the air, power consumption or ambient light levels and alert an operator to various conditions in the environment.

In a preferred embodiment, the LED kit also includes a control unit that communicates by a wireless transceiver to other LED lights and passes information to a LED light acting as a gateway to a local computer, hand held device (e.g. mobile phone), and/or to the Internet via a router. Remote monitoring and control of the lights can be anywhere that the Internet can be accessed.

In a preferred embodiment, the LED kit also includes a heat sink for controlling and dissipating the heat from the LED bulb.

In another embodiment, the LED kit LED bulb is configured for a temporary boost in power exceeding thermal limits, if directed by a network control computer.

In another embodiment, the LED kit LED replacement bulb utilizes multiple LED bulbs.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is an illustration of a perspective view of an embodiment of an LED retrofit kit with integrated Internet connectivity.

FIG. 2 is an illustrate of a top view of the LED retrofit kit of FIG. 1.

FIG. 3 is an illustration of a flow chart showing multi-directional communication between the various bulbs of a retrofit kit with an LED bulb configured for Internet communication.

FIG. 4 is a flow chart illustrating the multi-directional communication between various components of an LED retrofit kit with integrated Internet connectivity.

### DISCLOSURE

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

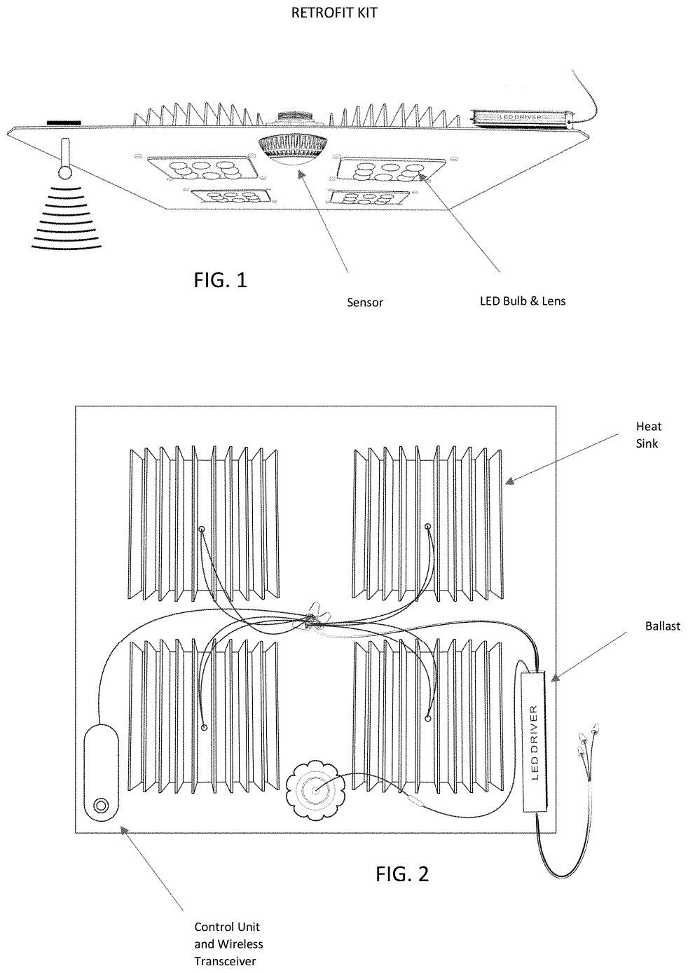

FIG. 1 depicts a perspective view of an embodiment of an LED retrofit kit 10 with integrated Internet connectivity. The view illustrates the retrofit kit when viewed from below as if it was installed in a lighting fixture. FIG. 2 depicts a top view of the LED retrofit kit of FIG. 1. In this preferred embodiment, depicted are four boards 12 of LED bulbs and lenses 14 each having eight LEDs as discussed above. A control unit 16 is shown in communication with a sensor 18 as discussed above. The control unit 16 further utilizes a transceiver for communicating to the Internet. The transceiver can be configured to communicate with the Internet via WIFI and/or via a cellular network. Alternative Internet connectivity can also be utilized. The control unit can further be configured to communicate directly to a nearby computer via wireless communication, such as by Bluetooth®. A bypass ballast 20 (also called an LED driver) is provided for supplying electrical current to the LEDs under the control of the control unit. Heat sinks 22 are provided for dissipating heat from the LEDs.

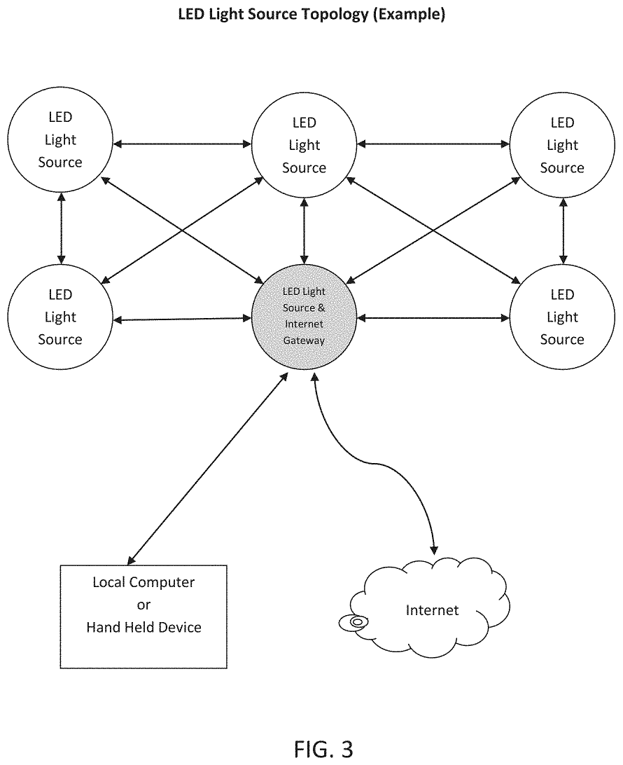

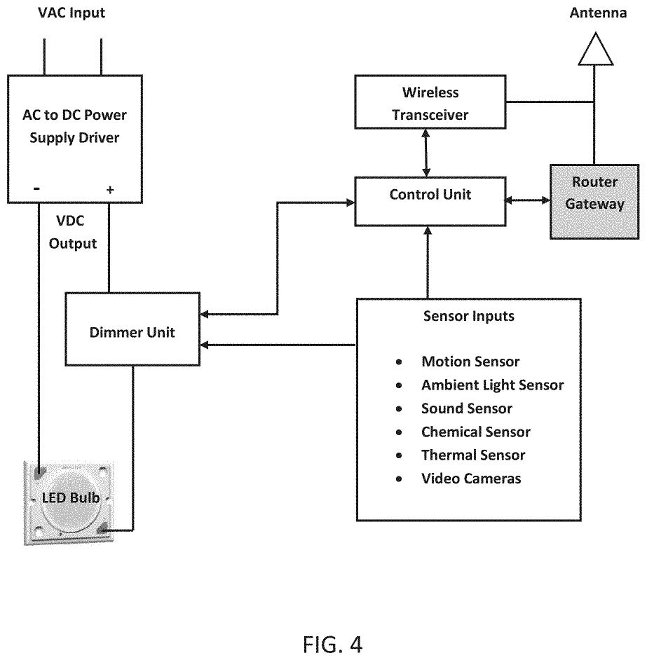

FIGS. 3 and 4 are diagrams showing multi-directional communication between the various components of a retrofit kit. FIG. 3 illustrates that preferably a LED bulb is configured to operate as the gateway connection to the Internet and/or other operable devices, such as a computer, cell phone, or other device. The LED bulb is configured to communicate to regulate LED bulbs mounted in the same fixture or in separate fixtures, such that a plurality of lights can be operable through a single LED bulb and Internet gateway.

FIG. 4 illustrates the connections between various elements of the retrofit kit. The kit has a control unit that is configured to control the LED light sources. A control unit is shown operatively connected to a wireless transceiver and a router. The router provides Internet connectability to the retrofit kit via the wireless transceiver and antenna. The control unit can be configured to control the dimmer unit in response to the sensor input. Alternatively or in addition to the control unit being configured to receive a signal from the sensor(s), the dimmer can be configured to control power to the LED bulb based on the direct signal from the sensor(s). A driver is shown functionally connected to control the electrical current to the LED bulb based on control signals from the control unit and/or dimmer. The dimmer and for example including a motion sensor, ambient light sensor, sounds sensor, chemical sensor, thermal sensor, or camera sensor.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A kit for retrofitting an existing high intensity discharge lamp, comprising:
a bypass ballast for supplying current to an LED replacement bulb;
at least one LED bulb;
a heat sink for controlling the heat from the LED bulb.
a dimmer unit, wherein said dimmer unit is configured for adjusting the light intensity of the LED bulb;
a controller, wherein said controller is configured to control said dimmer and configured to communicate via the Internet to an external device; and
a router and wireless transceiver configured to send and receive Internet communication between said controller and said external device.

2. The LED retrofit kit of claim 1, further comprising at least one sensor configured to sense an ambient condition and provide a signal to at least one of said dimmer and said controller.

3. The LED retrofit kit for retrofitting an existing high intensity discharge lamp of claim 1, in which said sensor is a motion detector, configured to signal for brighter light when motion is detected.

4. The LED retrofit kit for retrofitting an existing high intensity discharge lamp of claim 1, in which said sensor is a light detector, configured to signal the dimmer switch for less or no light when daylight is detected, and for brighter light when daylight is not detected.

5. The LED retrofit kit for retrofitting an existing high intensity discharge lamp of claim 1, in which said sensor is a sound detector, configured to signal the dimmer switch for brighter light when sound is detected.

6. The LED retrofit kit for retrofitting an existing high intensity discharge lamp of claim 1, in which said dimmer is controllable remotely from a local network control computer or remotely through the Internet.

7. The LED retrofit kit for retrofitting an existing high intensity discharge lamp of claim 1, in which said LED bulb is configured for a temporary boost in power exceeding thermal limits, if directed by a network control computer.

8. The LED retrofit kit for retrofitting an existing high intensity discharge lamp of claim 1, in which said LED replacement bulb comprises a plurality of LED bulbs.

9. The LED retrofit kit for retrofitting an existing high intensity discharge lamp of claim 8, in which a first LED bulb is configured to communicate to the Internet, wherein said first LED bulb is configured to communicate with a plurality of LED bulbs to control said plurality of LED bulbs based on Internet communications received by said first LED bulb via said router and wireless transceiver.

10. The LED retrofit kit for retrofitting an existing high intensity discharge lamp of claim 1, wherein a plurality of said LED retrofit kits are configured for communication with one another via the Internet.
